(19) United States
(12) Patent Application Publication
(10) Pub. No.: US 2011/0135099 A1
(43) Pub. Date: Jun. 9, 2011

(54) ADAPTIVE PREFILTER-PREMIXER FOR SOUND REPRODUCTION

(75) Inventors: Jacob Gunther, North Logan, UT (US); Todd Moon, Providence, UT (US)

(73) Assignee: Utah State University, North Logan, UT (US)

(21) Appl. No.: 12/962,279

(22) Filed: Dec. 7, 2010

Related U.S. Application Data
(60) Provisional application No. 61/267,156, filed on Dec. 7, 2009.

(51) Int. Cl. H04R 5/00; H04B 3/00

(52) U.S. Cl. 381/17; 381/80

(57) ABSTRACT

Adaptive learning of a multichannel prefilter response processes multiple audio signals prior to emitting them from a set of loudspeakers. The signals are filtered and mixed in such a way that the emitted signals will be reconstructed at pre-specified points in a room. This is done in a user selective way so that, at each location, only one of the source signals is reconstructed and the other signals vanish. A gradient descent adaptive filtering method is applied.

### RELATED APPLICATIONS

This application claims the benefit under 35 U.S.C. §119(e) of U.S. Provisional Patent Application No. 61/267,156, filed Dec. 7, 2009, and titled “Adaptive Prefilter-Premixer for Sound Reproduction” which is incorporated herein by reference.

### GOVERNMENT SUPPORT CLAUSE

This invention was made with government support under contract H98230-09-0108 awarded by the National Security Agency. The government has certain rights in the invention.

### TECHNICAL FIELD

The present invention relates to controlling sound from a set of loudspeakers.

### BACKGROUND

Traditionally, recorded and broadcast audio carried stereo sound, that is two channels of sound. Therefore, traditional sound systems consisted of mainly two loudspeakers. Today sound systems with multiple speakers are proliferating. Home entertainment systems, car stereos, and computer sound systems often have arrays of loudspeakers to produce immersive audio effects. In public spaces such as shopping malls, stores, airports, conference centers, sports arenas, and other buildings, many speakers are deployed. Usually, these systems are constructed to convey a single source message, be it music or speech, to a multitude of people. We disclose an apparatus and method for simultaneously conveying several independent sound sources to two or more people within a room or enclosure, taking advantage of the presence of multiple loudspeakers.

### DESCRIPTION OF THE FIGURES

FIG. 1. Shows the physical configuration of two microphones and three loudspeakers in a room. The prefilter-premixer accepts two signals that are to be reproduced at locations A and B, respectively, and produces signals to drive the speakers.

FIG. 2. Signal processing block diagram model of the physical system in FIG. 1.

FIG. 3. Impulse responses for a room with two loudspeakers and two microphones.

FIG. 4. Mean square errors for the prefilter (MSE) and for the system identification (MSEᵢ) for independent noisy input signals.

FIG. 5. Combined impulse response of the learned response of the prefilter and the room for noisy input signals.

FIG. 6. Mean square errors for the prefilter (MSE) and for the system identification (MSEᵢ) for independent speech input signals.

FIG. 7. Combined impulse response of the learned response of the prefilter and the room for speech input signals.

### DETAILED DESCRIPTION OF THE INVENTION

We utilize a system of multiple speakers 110, 111, 112 to form two independent sounds at two different locations 101, 102 in a room. In one location 11, s₁(t) is produced, and in another location 102 s₂(t) is produced. Given s₁(t) and s₂(t), we disclose a system for preprocessing signals to produce a set of speaker signals x₁(t), 1=1, 2, . . . , L, 120, 121, 122 such that when the emitted sounds from the speakers pass through the room and interfere at points A 101 and B 102, signal s₁(t) is reproduced at A and signal s₂(t) is reproduced at B.

We disclose the method of prefiltering and premixing 130 a set of source signals to prepare them for emission from a set of loudspeakers. The prefiltering is done to cause the emitted signals 120, 121, 122 to interfere at locations in the room such that there is constructive interference for only one of the source signals at that point. All others destructively interfere. By so doing, we can reconstruct desired signals at a few locations in a room. This disclosure develops an LMS-type adaptive algorithm for the prefilter and demonstrates its effectiveness in example situations using both noise and speech input signals. While noisy inputs lead to rapid and highly accurate adaptation, speech signals require many updates to reach steady state. The sound field at the points of interest may be measured by means of microphones.

Suppose that M signals sᵢ(n), i=1, 2, . . . , M are to be reproduced at M locations in a room. Let yᵢ(n), i=1, 2, . . . , M be the microphone signals measured at these locations 123, 124. Furthermore, let xᵢ(n), i=1, 2, . . . , L be the loudspeaker signals emitted into the room. We arrange these sets of signals and measurements into the vectors

$$s ( n ) = [ \begin{matrix}s 1 ( n ) \\ ⋮ \\ sM ( n )\end{matrix} ] , x ( n ) = [ \begin{matrix}x 1 ( n ) \\ ⋮ \\ xM ( n )\end{matrix} ] , y ( n ) = [ \begin{matrix}y 1 ( n ) \\ ⋮ \\ yM ( n )\end{matrix} ] . \qquad ( 1 )$$

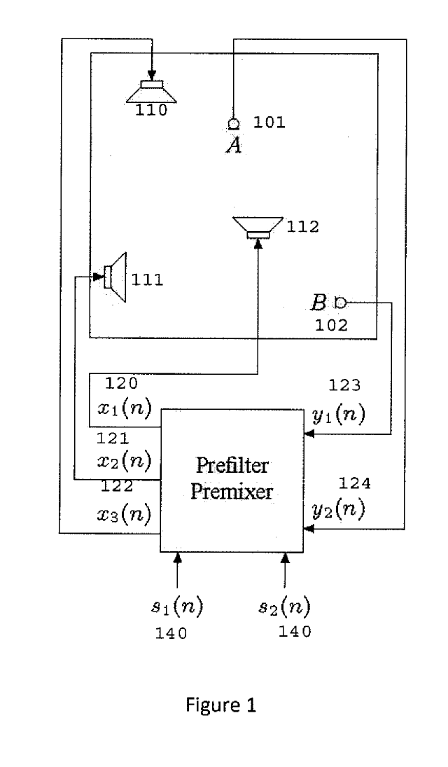

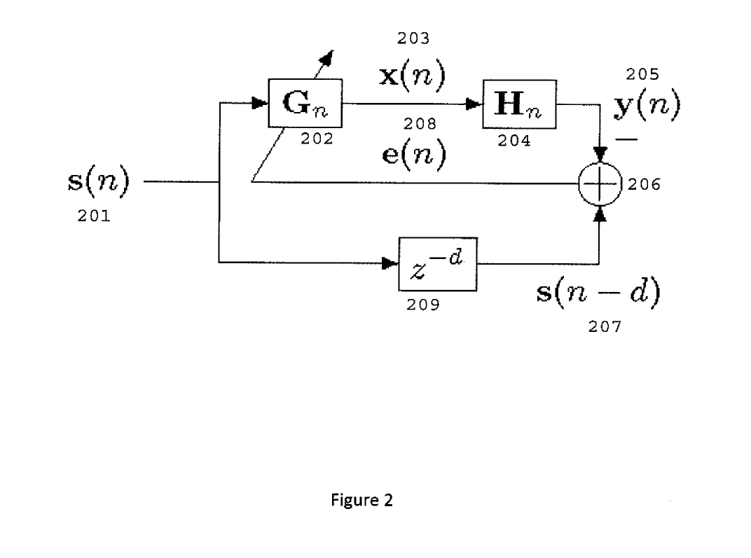

A Finite Impulse Response (FIR) filter is a type of a digital filter. The impulse response, the filter's response to a Kronecker delta input, is finite because it settles to zero in a finite number of sample intervals. Let Gₙ, n=0, 1, . . . , N_{G}−1 be the impulse response of an Finite Impulse Response M-input, L-output system that prefilters and combines the signals in s(n) to form the loudspeaker signals x(n). Each “tap” in this system is a L×M matrix. Model the room by an FIR input, M-output system with impulse response Hₙ, n=0, 1, . . . , N_{H}−1 that filters and combines the loudspeaker signals 130 in x(n) 120, 121, 122 to produce the microphone signals y(n) 123, 124. Each “tap” in this system is a M×L matrix. We desire to reproduce the signals in s(n) 140 at the microphones with some suitable delay which, in one embodiment, is assumed to be the same for each signal. Let d denote the delay, then the objective is y(n)=s(n−d). To achieve this objective, we choose the filter coefficients Gₙ 202. The room response Hₙ 204 is unknown and may be time varying. A physical system diagram is shown in FIG. 1, and a signal processing block diagram is shown in FIG. 2.

The multichannel convolutions involved in computing x(n) 203 and y(n) 205 are:

x(n)=Gₙ*s(n)=Σₖ₌₀^{N}^{_{G}}⁻¹Gₖs(n−k). (2)

y(n)=Hₙ*x(n)=Σₖ₌₀^{N}^{_{H}}⁻¹Hₖ×(n−k). (3)

The (i, j)^{th} element of the matrix sequence Gₙ 202 is the impulse response g_{i,j}(n) of the filter between the j^{th} source signal and the i^{th} loudspeaker. Similarly, the (i,j)^{th} element of the matrix sequence Hₙ 204 is the impulse response (n) of the room between the j^{th} loudspeaker and the microphone.

Let 208 e(n)=s(n−d)−y(n) 207, 205 be the error between the microphones and the desired signals. This section designs one embodiment of an adaptive filtering algorithm for the prefilter Gₙ 202 that minimizes the mean squared error

MSE=E{e^{T}(n)e(n)}. (4)

To this end, substitute (2) into (3) to obtain

y(n)=Hₙ*Gₙ*s(n). (5)

Even though (5) shows a linear dependence upon the filter Gₙ, we desire to rewrite (5) in such a way that the G terms appear farthest to the right. Doing so will make easier the taking of the derivative of the MSE with respect to Gₙ. To this end, apply the identity Gs=(I [symbol] s^{T}(n))vec(Gₙ^{T}) to (2), where vec( ) is a column scanning operator. Then (5) can be written as

y(n)=Hₙ·(I [symbol] s^{T}(u))*vec(Gₙ^{T}). (6)

Define

Zₙ=Hₙ(I [symbol] s^{T}(H))=(Hₙ [symbol] 1)*(I [symbol] s^{T}(n)) (7)

=Hₙ* [symbol] s^{T}(n)==Σₖ₌₀^{N}^{_{H}}⁻¹Hₖ [symbol] s^{T}(n−k). (8)

The matrix Zₙ is M×LM. The (i, jM+k)^{th} element of the matrix sequence Zₙ is given by h_{i,j}(n)*sₖ(n) which is the k^{th} signal passed through the filter representing the response of the room between the j^{th} loudspeaker and the i^{th} microphone. Unfortunately, not only are these signals not available, it is not practical to measure them. To measure them would require emitting one of the signals from one of the speakers while holding all the other speakers silent and recording the sound field on one of the microphones. This would have to be done for every signal and every speaker-microphone pair. The impracticality of this will be addressed further ahead. For now, we proceed with the derivation of the adaptive filtering algorithm.
Define gₙ=vec(Gₙ^{T}) and substitute (8) into (6) to obtain

$$\begin{matrix}y ( n ) = {Z}_{n} \cdot {g}_{n} = {\sum }_{k = 0}^{{N}_{G} - 1} {Z}_{n - k} {g}_{k} = {Φ}_{n} γ , & ( 9 ) \\ {Φ}_{n} = {[ \begin{matrix}{Z}_{n}^{T} \\ {Z}_{n - 1}^{T} \\ ⋮ \\ {Z}_{n - {N}_{G} + 1}^{T}\end{matrix} ]}^{T} , γ = [ \begin{matrix}{g}_{0} \\ {g}_{1} \\ ⋮ , \\ {g}_{{N}_{G} - 1}\end{matrix} ] . & ( 10 )\end{matrix}$$

Using (9) the error 208 can be written as

e(n)=s(n−d)−Φₙγ. (11)

Then the gradient of the MSE in (4) with respect to γ is

$$\frac{\partial MSE}{\partial γ} = - 2 E \{ {Φ}_{n}^{T} e ( n ) \} . \qquad ( 12 )$$

An LMS-style adaptive update rule that follows from (12) is

γₙ₊₁=γₙ+μΦₙ^{T}e(n). (13)

However, Φₙ^{T} in the update in (13) is neither known nor measurable. We observe, however, that Φₙ is computable if the room response Hₙ were known. To this end, in parallel with the adaptive update in (13), we update a second adaptive filter that will identify the unknown room response. The excitations for this system identification process are the loudspeaker signals which are known. The outputs are the measured microphone signals. Everything is already in place and no new signals or measurements are needed. The Φₙ values computed using the estimated model are used in the adaptive update for Gₙ in (13).

Let Ĥₙ be the impulse response of the system identification adaptive filter and let ŷ(n) be its output when the input is taken as the loudspeaker signal x(n), then

$$\begin{matrix}\hat{y} ( n ) = {\hat{H}}_{n} * x ( n ) = {\sum }_{k = 0}^{{N}_{H} - 1} {\hat{H}}_{k} x ( n - k ) = Γξ ( n ) , & ( 14 ) \\ Γ = {[ \begin{matrix}{\hat{H}}_{0}^{T} \\ {\hat{H}}_{1}^{T} \\ ⋮ \\ {\hat{H}}_{{N}_{H} - 1}^{T}\end{matrix} ]}^{T} , ξ ( n ) = [ \begin{matrix}{x}_{n} \\ {x}_{n - 1} \\ ⋮ , \\ {x}_{n - {N}_{H} + 1}\end{matrix} ] . & ( 15 )\end{matrix}$$

Let f(n) be the system identification error,

f(n)=y(n)−\hat{y}(n). (16)

Taking the derivative of the mean-square identification error

MSEᵢ=E{f^{T}(n)f(n)} (17)

leads to

$$\frac{\partial {MSE}_{i}}{\partial Γ} = - 2 E \{ f ( n ) {ξ ( n )}^{T} \} , \qquad ( 18 )$$

from which the following LMS-style adaptive update is obtained,

Γ_{η+1}=Γ_{η}+ρf(η)ξ^{T}(η). (19)

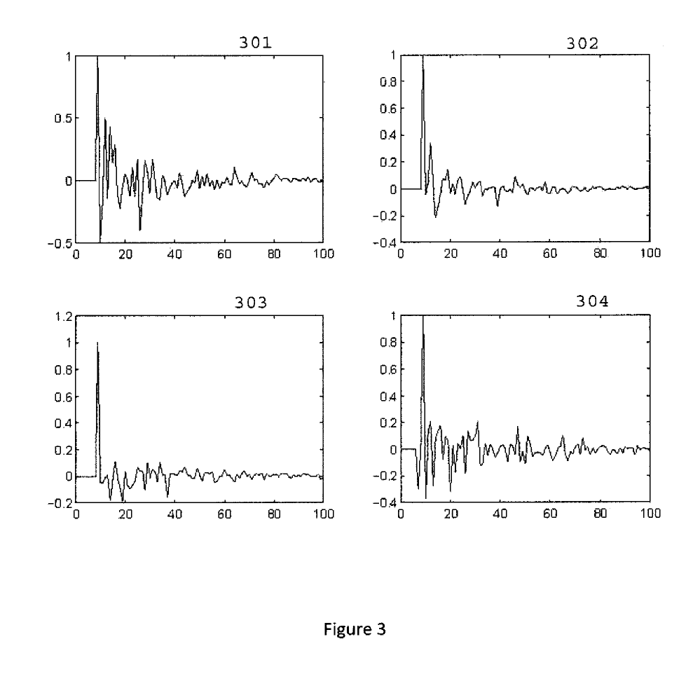

The signal reconstruction system of FIG. 1 is arranged in a two microphone, two loudspeaker configuration. The room impulse responses are measured. These responses are downsampled to obtain room responses that are 100 samples long. The resulting room impulse responses 301, 302, 303, 304 are shown in FIG. 3.

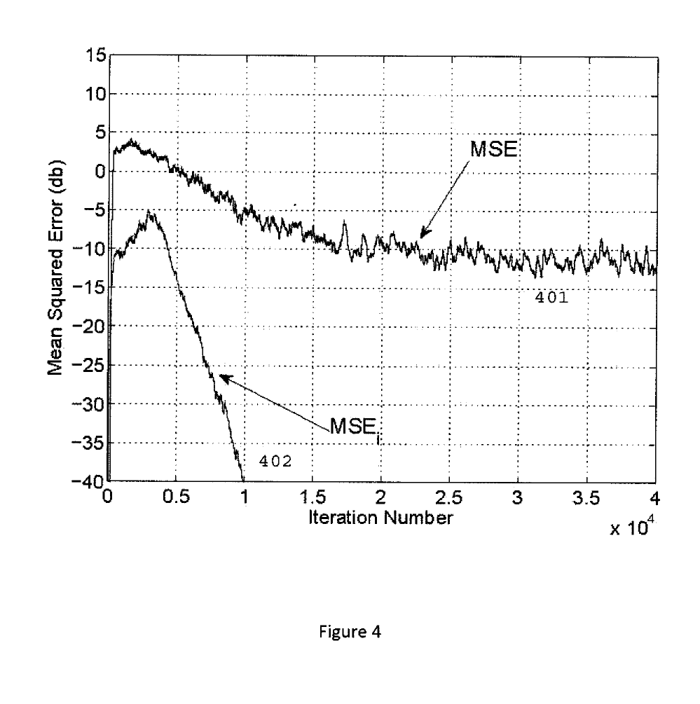

We show examples using two types of input signals: noise and speech. In the first example, we ran noise into the adaptive signal reconstruction system. The prefilter Gₙ and room model Hₙ were adapted according to equations (13) and (19) using μ=0.0005 and ρ=0.005. These step sizes are chosen so that the system identification filter would adapt more quickly than the prefilter. The prefilter was chosen to have length 300 matrix taps and the system identification filter was chosen to have 100 taps, the same number as the actual system. The system delay was d=200 samples. FIG. 4 shows mean squared error learning curves for the two adaptive filters 401, 402. The curve 401 labeled MSE corresponds to MSE=E{e^{T}(n)e(n)} is the mean squared error of the prefilter, while the curve 402 labeled MSEᵢ=E{f^{T}(n) f} is the mean squared error for the system identification filter. The example was run for 40,000 time steps with one adaptive update step for each sample processed. The mean squared error for the system identification process decreases rapidly and falls below −40 dB (0.0001) after processing 10,000 samples. This indicates very close agreement between the model room response Ĥₙ and the actual room response Hₙ. The mean squared error of the prefilter decreases more slowly and reaches a steady state value after about 20,000 samples.

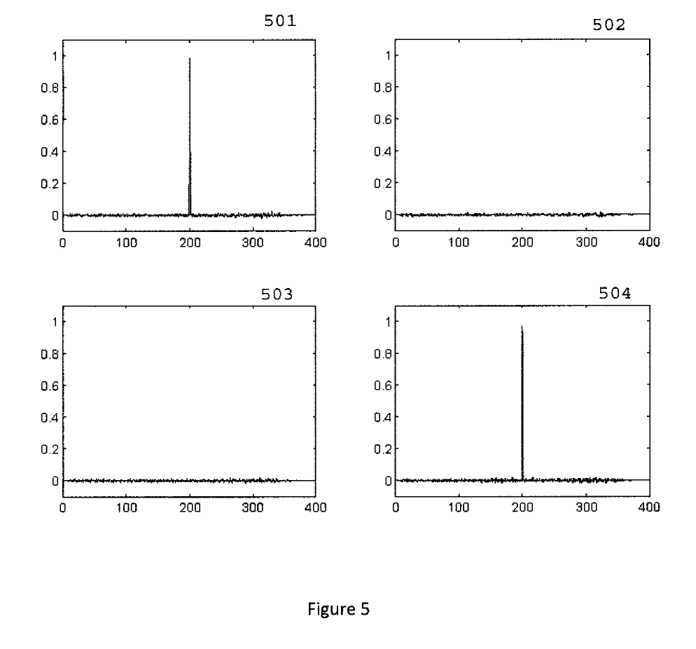

To assess the quality of the prefilter learned through this simulation, the overall system impulse response was computed. That is, let Cₙ=Hₙ*Gₙ. Ideally, the overall system response would be Cₙ=Iδ(n−d), and the learned response is quite close to this ideal as illustrated 501, 502, 503, 504 in FIG. 5.

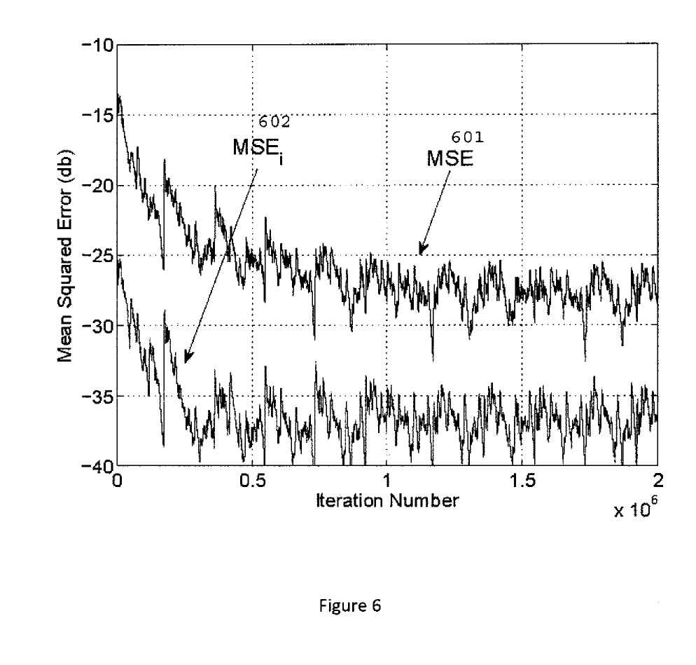

The near ideal performance of the signal reconstruction algorithm in the preceding example is attributable to the noisy inputs which are statistically exciting. The preceding example was repeated with the only change being that a pair of speech signals were used instead of noise. One signal is a man's voice and the other is a woman's. The same filter lengths and delay were used. The computation was run for 2,000,000 samples. Each of the audio files contained about 150,000 samples so the entire files were processed several times over the course of the simulation. Over the first million samples, the adaptive step sizes were set to =0.0005 and p=0.005, the same as in the previous experiment. Over the second million samples, the adaptive step sizes were decreased by a factor of ten to μ=0.00005 and ρ=0.0005. The mean squared error learning curves 601, 602 are shown in FIG. 6. The initial learning transients were much longer for the speech inputs. The system identification process reached steady state after about 300,000 samples, whereas the prefilter adaptive process required nearly 1,000,000 samples.

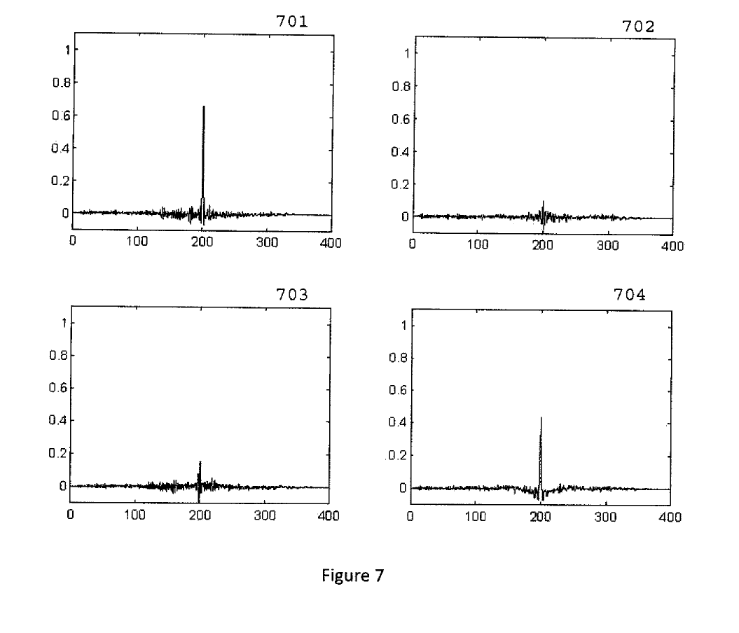

The overall system impulse response 701, 702, 703, 704 learned with speech inputs is shown in FIG. 7. Notice that a small amount of cross channel interference remains.

The above description discloses the invention including preferred embodiments thereof. The examples and embodiments disclosed herein are to be construed as merely illustrative and not a limitation of the scope of the present invention in any way. It will be obvious to those having skill in the art that many changes may be made to the details of the above-described embodiments without departing from the underlying principles of the invention.

We claim:

1. A system for sound reproduction comprising:
a plurality of speakers,
speaker input signals to at least two of said plurality of speakers,
a device controlling said speaker input signals, and
said device controlling said speaker input signals causing a first sound at a first location and
causing a second sound at a second location.

2. The system of claim 1 further comprising:
characterization of said system response by measuring the response from said plurality of speakers at said first location and at said second location.

3. The system of claim 2 wherein:
said characterization of said system response is measured using a microphone.

4. The system of claim 1 wherein:
said first sound is the result of destructive interference, and
said second sound is the result of constructive interference.

5. The system of claim 1 further comprising:
a least mean squares prefilter applied by said controlling device to said speaker input signals.

6. A method for sound reproduction comprising:
inputting a first signal to at first speaker,
inputting a second signal to a second speaker,
controlling said first and second speaker inputs to generate a first sound at a first location, and
to generate a second sound at a second location.

7. The method of claim 6 further comprising:
measuring the response from said plurality of speakers at said first location and at said second location.

8. The method of claim 7 wherein:
measuring the response from said plurality of speakers at said first location and at said second location uses a microphone.

9. The method of claim 6 wherein:
controlling said first and second speaker inputs to generate destructive interference at said first location and generates constructive interference at said second location.

10. The method of claim 1 further comprising:
applying a least mean squares prefilter to said speaker input signals.
